(19) United States
(12) Patent Application Publication
(10) Pub. No.: US 2025/0192528 A1
(43) Pub. Date: Jun. 12, 2025

(54) EXPANDABLE ELECTRICAL BOX

(71) Applicant: OneBoxForAll LLC, Ashburn, VA (US)

(72) Inventors: Michael Lee SIMMONS, Haymarket, VA (US); Avi Rosenthal, Ashburn, VA (US)

(21) Appl. No.: 18/927,372

(22) Filed: Oct. 25, 2024

Related U.S. Application Data
(60) Provisional application No. 63/608,198, filed on Dec. 9, 2023.

(51) Int. Cl. H02G 3/08

(52) U.S. Cl. CPC H02G 3/086; H02G 3/081

(57) ABSTRACT

An expandable electrical box can comprise a housing comprising a rear wall, a top wall, a bottom wall and a fixed side wall defining an interior space, an open side opposite the fixed side wall, wherein a front of the housing is open, and a first fixture member connected to the housing, and a removable side wall configured to releasably cover the open side of the housing, the removable side wall comprising a second fixture member connected to the removable side wall, wherein the first fixture member and the second fixture member are aligned to receive a fastener therethrough.

### CROSS REFERENCE TO RELATED APPLICATION

This application claims priority to U.S. Provisional Application Ser. No. 63/608,198, filed Dec. 9, 2023, the benefit of priority of which is claimed herein, and which application is incorporated herein by reference in its entirety.

### BACKGROUND

### Field

The disclosure of the present patent application relates to electrical boxes that are expandable to receive any desired number of electrical outlet modules, light switch modules or the like. More specifically, but not by way of limitation, the disclosure of the present application relates to features for allowing modular components of expandable electrical boxes to connect to each other in a variety of different configurations.

### Description of Related Art

Electrical boxes are commonly used to receive, mount and protect a variety of electrical modules, such as electrical outlet modules, light switch modules, etc. Many electrical boxes can be used in the interior of residential, commercial and industrial buildings. Typical electrical boxes are mounted to a wall flush with the exposed surface of the wall. Thus, electrical boxes are typically recessed into a cavity within the wall. Single, double and triple electrical outlets and light switches are common. Traditional electrical boxes are manufactured in a variety of different sizes to accommodate the variety of different possible configurations, e.g., single, double and triple electrical module sizes. However, manufacturing multiple sizes of electrical boxes requires additional time effort and cost for the manufacturer. Consequently, it can be inconvenient and expensive for the consumer to have to purchase multiple sizes of electrical boxes. Expandable electrical boxes have been developed in attempts to solve these problems.

### SUMMARY

The present inventors have recognized that many expandable electrical boxes can be difficult to assemble. For example, it can be difficult to align features intended to connect modular components of the expandable electrical boxes. Furthermore, many expandable electrical boxes can be loose or not precisely aligned when assembled. These problems can be exacerbated when considering expandable electrical boxes that are installed into existing wall structures. For example, loose and misaligned modular components can be difficult to fit into existing wall openings, such as when it is desirable to expand an already-installed, two-electrical-module electrical box (e.g., a “two-gang box”) into a three-electrical-module electrical box.

The disclosure of the present application can provide solutions to these and other problems by providing expandable electrical boxes having modular components that can be easily aligned and assembled together. Coupling members, or fixture members, of the disclosure of the present application can be easily aligned and secured to each other in a rigid and fixed manner, such as by using fasteners that tightly retain the modular components in an assembled configuration. Additionally, the fixture members can be incorporated into different types of modular components, such as housing components, removable wall components, expansion boxes and auxiliary boxes. Furthermore, the fixture members of the disclosure of the present application can be applied to both new work boxes and old work boxes, thereby allowing easy installation into new wall construction and into existing wall openings.

An expandable electrical box can comprise a housing comprising a rear wall, a top wall, a bottom wall and a fixed side wall defining an interior space, an open side opposite the fixed side wall, wherein a front of the housing is open, and a first fixture member connected to the housing, and a removable side wall configured to releasably cover the open side of the housing, the removable side wall comprising a second fixture member connected to the removable side wall, wherein the first fixture member and the second fixture member are aligned to receive a fastener therethrough.

A removable wall for an expandable electrical box can comprise . . . a wall panel comprising a top side, a bottom side, a rear side, a front side, an interior surface bounded by the top side, the bottom side, the rear side and the front side, and an exterior surface bounded by the top side, the bottom side, the rear side and the front side; a first flange extending from interior surface flush the top side and the front side, the first flange comprising a first fastener bore for receiving a first fastener; and a second flange extending from the interior surface flush with the bottom side and the front side, the second flange comprising a second fastener bore for receiving a second fastener.

An expandable electrical box system can comprise a housing, a removable side wall and an expansion member. The housing can comprise a rear wall, a top wall, a bottom wall, a fixed side wall and an open side opposite the fixed side wall, wherein a front of the housing is open, and a first fixture member connected to the housing. The removable side wall can be configured to releasably cover the open side of the housing, the removable side wall comprising a second fixture member connected to the removable side wall, wherein the first fixture member and the second fixture member are aligned to receive a fastener therethrough. The expansion member can comprise a rear expansion wall, a top expansion wall, a bottom expansion wall, a first open side and a second open side, a first expansion fixture member mounted on the rear expansion wall adjacent the first open side for engaging the first fixture member of the housing, and a second expansion fixture member mounted on the rear expansion wall adjacent the second open side for engaging the second fixture member of the removable side wall.

These and other features of the present subject matter will become readily apparent upon further review of the following specification.

### BRIEF DESCRIPTION OF DRAWINGS

FIG. 1 is a perspective view of an expandable electrical box of the present disclosure showing a removable side wall exploded from a housing.

FIG. 2 is a perspective view of the expandable electrical box of FIG. 1 in an assembled state to receive a single electrical component.

FIG. 3 is a perspective view of the removable side wall of the expandable electrical box of FIG. 1, showing an interior side thereof.

FIG. 4 is a perspective view of the removable side wall of the expandable electrical box of FIG. 1, showing an exterior side thereof.

FIG. 5 is a perspective view of an expansion member of the expandable electrical box configured to be positioned between the housing and the removable side wall of FIG. 1 to receive an additional electrical component.

FIG. 6 is a perspective view of the expandable electrical box of FIG. 1 with three expansion members installed between the housing and the removable side wall so that the expandable electrical box can receive four electrical components.

FIG. 7A is a perspective view of an auxiliary box for the expandable electrical box of FIG. 1 having a storage space portion and an expansion member portion exploded from the housing and the removable side wall removed.

FIG. 7B is a cross-sectional view through the auxiliary box of FIG. 7A showing an interior storage space of the storage space portion.

FIG. 8 is a perspective view of another example of an auxiliary box having a storage space portion configured to be attached directly to another component without an expansion member portion.

FIG. 9 is an exploded perspective view of another embodiment of an expandable electrical box of the present disclosure comprising a housing and a removable sides wall each having a pair of pivoting tabs.

FIG. 10A and FIG. 10B are exploded perspective views of another alternative embodiment of an expandable electrical box of the present disclosure comprising a housing and a removable side wall each having a single pivoting tab.

FIG. 11A and FIG. 11B are perspective views of an expansion member suitable for use with the expandable electrical box of FIG. 10A and FIG. 10B.

FIG. 12 is a top view of the expandable electrical box of FIG. 10B showing interlocking features of the housing and the expandable side wall.

FIG. 13 is a top view of the expansion member of FIG. 11A showing interlocking features for engaging with the housing and expandable side wall.

Similar reference characters denote corresponding features consistently throughout the attached drawings.

### DETAILED DESCRIPTION

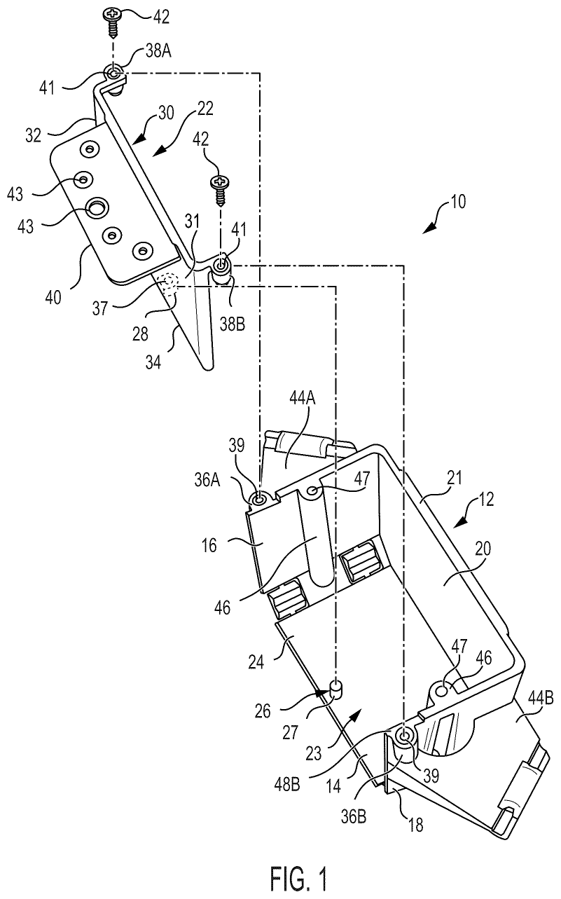

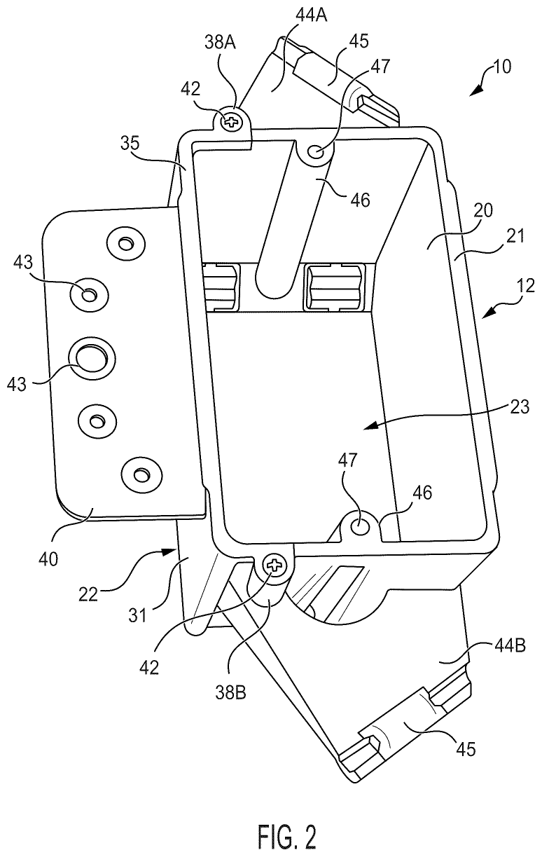

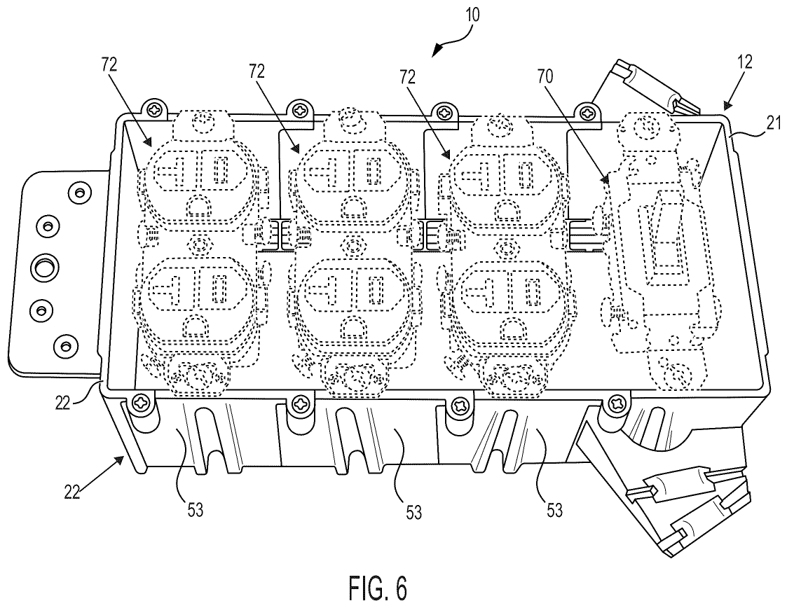

FIG. 1 is a perspective view of expandable electrical box 10 of the present disclosure showing removable side wall 22 exploded from housing 12. FIG. 2 is a perspective view of expandable electrical box 10 of FIG. 1 in an assembled state to receive a single electrical component, such as electrical outlet module 70 and light switch module 72 shown in FIG. 6. As shown in FIG. 1 and FIG. 2, expandable electrical box 10 can include housing 12 having rear wall 14, top wall 16, bottom wall 18, fixed side wall 20 and an open side opposite of fixed side wall 20. Top wall 16, bottom wall 18 and fixed side wall 20 can form front surface 21. Removable side wall 22 is provided for releasably covering the open side of housing 12. When assembled, rear wall 14, top wall 16, bottom wall 18, fixed side wall 20 and removable side wall 22 form a five-sided receptacle having interior space 23. The front of housing 12 can be open to receive one of electrical outlet module 70 and light switch module 72 shown in FIG. 6 within interior space 23. That is, interior space 23 provides a cavity configured to receive one or more modules.

Housing 12 can be sized or dimensioned similarly to a conventional electrical box for receiving an electrical outlet module, a switch module or the like. However, it should be understood that the overall configuration, size and relative dimensions of housing 12 are shown in FIG. 1 and FIG. 2 for exemplary purposes only and the features of the disclosure of the present application, such as the various fixture members, coupling members, receiving members, engaging members and the like, can be incorporated into expandable electrical boxes having other shaped housings. For example, rear wall 14, top wall 16, bottom wall 18, fixed side wall 20 and removable side wall 22 can be disposed generally orthogonal to each other such that interior space 23 is generally a rectangular prism or cuboid shape, though other configurations can be used. Additionally, although described with reference to a particular orientation, expandable electrical box 10 can be used in multiple orientations, such as for left-sided or right-sided vertical mounting, horizontal mounting, or can be otherwise oriented.

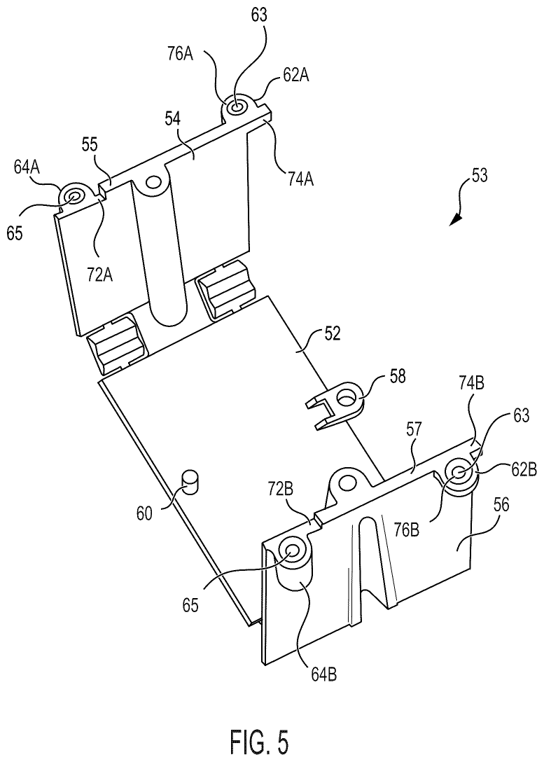

Removable side wall 22 can be configured to be attached to housing 12 to form interior space 23 to allow the assembly to receive a single electrical component (e.g., in a one-gang box configuration) or allow for expansion member 53 (FIG. 5) to be attached between housing 12 and removable side wall 22 to allow the assembly to receive two electrical components (e.g., in a two-gang box configuration). As discussed herein, removable side wall 22 can be configured to be removed, or “pulled out,” from housing 12 by being translated straight away from rear wall 14 in a direction parallel to fixed side wall 20, thereby facilitating use and expansion in old work situations as described herein.

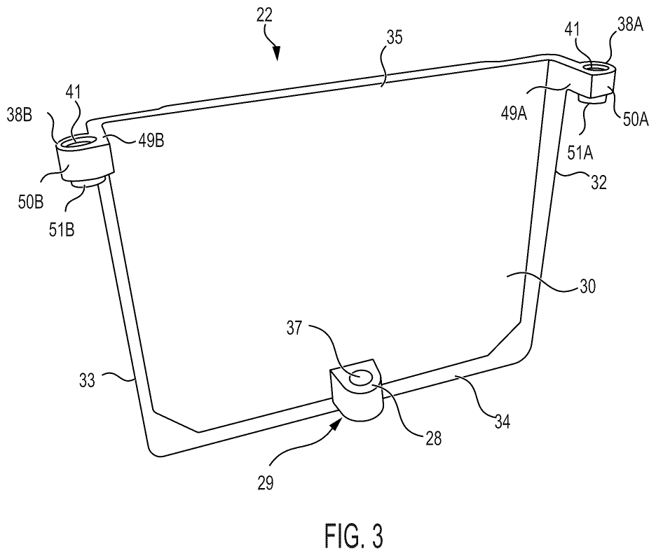

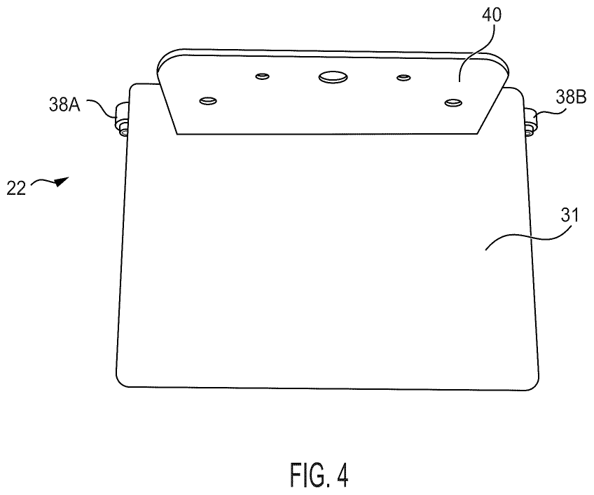

FIG. 3 and FIG. 4 are perspective views of removable side wall 22 of expandable electrical box 10 of FIG. 1, showing interior face 30 and exterior face 31, respectively. Removable side wall 22 can comprise top edge 32, bottom edge 33, rear edge 34 and front edge 35. Interior face 30 can be formed between top edge 32, bottom edge 33, rear edge 34 and front edge 35 on an inside surface of removable side wall 22, and exterior face 31 can be formed between top edge 32, bottom edge 33, rear edge 34 and front edge 35 on an exterior surface of removable side wall 22.

In examples, receiving member 28 (FIG. 3) is mounted on interior face 30 of removable side wall 22, adjacent to rear edge 34 thereof. Engaging member 26 (FIG. 1) can be mounted on interior face 24 of rear wall 14, adjacent to the open side of housing 12. Receiving member 28 can be adapted for releasably receiving engaging member 26 to releasably attach removable side wall 22 to rear wall 14 of housing 12. Receiving member 28 can comprise flange 29 projecting from removable side wall 22 at rear edge 34, wherein flange 29 includes opening 37 to receive engaging member 26. Engaging member 26 can comprise projection 27 or peg extending from rear wall 14. In examples, opening 37 can extend along a central axis parallel to interior face 30, and projection 27 can extend a long a central axis parallel to fixed side wall 20. In examples, opening 37 can comprise a circular hole and projection 27 can comprise a cylindrical peg. As such, in examples, engaging member 26 and receiving member 28 can be configured for “pull out” removal of removable side wall 22.

Although engaging member 26 is shown as having a peg-like shape, and receiving member 28 is shown as being configured to mate with the peg-like example of engaging member 26, it should be understood that the size, shape and relative dimensions of the engaging member 26 and the receiving member 28 are shown for exemplary purposes only, as other shapes and sizes of engaging member 26 and receiving member 28 are also contemplated within the scope of the present subject matter, such as square pegs and holes and the like. In examples, engaging member 26 can be provided on removable side wall 22 and receiving member 28 can be provided on housing 12.

As shown in FIG. 1 and FIG. 2, housing 12 is shown as having top flange 44A and bottom flange 44B provided for mounting on or within a wall. Top flange 44A and bottom flange 44B can comprise sleeves 45 for receiving a fastener to secure housing 12 to a wall. In examples, nails can be driven through each of sleeves 45 to secure housing 12 to a wall or an internal component within a wall such as a stud. However, housing 12 can have any suitable type of fixation features or mounts for connecting to walls or wall components.

Housing 12 is shown as having a pair of screw receivers 46 that can be located on an inside of housing 12. Screw receivers 46 can include bores 47 to receive fasteners, such as a screw, to secure an electrical component within interior space 23. However, it should be understood that these screw receivers 46 are shown for exemplary purposes only and housing 12 can include other means or structure for receiving mounting an electrical component, such as flanges or projections for receiving one or more fasteners.

Fixture member 36A and fixture member 36B can be respectively mounted on or near front edges of the top wall 16 and the bottom wall 18 of housing 12 at front surface 21, adjacent to the open side. Fixture member 38A and fixture member 38B can also be respectively mounted on opposed sides of a front edge 35 of the removable side wall 22. Fixture member 36A and fixture member 36B can be adapted for releasably engaging with fixture member 38A and fixture member 38B. Fixture member 36A and fixture member 36B can each have a passage 39 formed therethrough and, similarly, fixture member 38A and fixture member 38B can each have passage 41 formed therethrough. Passages 41 can align with passages 39 when removable side wall 22 is engaged with housing 12. Passages 39 and passages 41 can be adapted for receiving fasteners 42 or the like for releasably securing removable side wall 22 to housing 12.

Front surface 21 can include notch 48A at fixture member 36A and notch 48B at fixture member 36B to receive fixture member 38A and fixture member 38B, respectively. Fixture member 36A and fixture member 36B can comprise bodies of material projecting outward from top wall 16 and bottom wall 18, respectively. The bodies of material can provide adequate surface area for threads of fasteners 42 to gain purchase with housing 12. The bodies of material can project outward from top wall 16 and bottom wall 18 to not interfere with the coupling of top wall 16 and bottom wall 18 with removable side wall 22 so that a contiguous wall structure can be formed and to not occupy space within interior space 23 that can be used for storing wiring, etc. As shown in FIG. 3, fixture member 38A can comprise extension 49A and body 50A, and fixture member 38B can comprise extension 49B and body 50B. Extension 49A and extension 49B can comprise flanges aligned with top edge 32 and bottom edge 33, respectively. Extension 49A and extension 49B can be configured to mate with notch 48A and notch 48B, respectively. Body 50A and body 50B can provide material for the formation of passages 41, respectively. Furthermore, body 50A can comprise peg 51A and body 50B can comprise peg 51B that can fit within counterbores in fixture member 36A and fixture member 36B, respectively, that surround passages 39. Thus, when fixture member 38A and fixture member 38B are engaged with fixture member 36A and fixture member 36B, respectively, front edge 35 will be flush with front surface 21, and fixture member 38A and fixture member 38B will be centered and locked with fixture member 36A and fixture member 36B, respectively.

As best seen in FIG. 4, mounting flange 40 is shown secured to exterior face 31 of removable side wall 22. Similar mounting flanges have been used in conventional, non-expandable electrical boxes. However, with the present disclosure, mounting flange 40 is provided as a feature of removable side wall 22 in various examples. It should be understood that mounting flange 40 is shown for exemplary purposes only and can be removed or can be replaced with any suitable type of structure having any suitable overall contouring, positioning, size and relative dimensions. In examples, mounting flange 40 can comprise a planar body extending from front edge 35 of removable side wall 22. Mounting flange 40 can be configured to fit alongside, e.g., in front of, a wall structure, such as a stud or another surface, to secure expandable electrical box 10. Mounting flange 40 can include one or more openings 43, such as holes, threaded bores or the like, to receive fasteners to attach mounting flange 40 to the wall structure. In an example, mounting flange 40 is frangible and can be separated from removable side wall 22.

Housing 12 and removable side wall 22 can be configured to be installed in a new construction project where the exterior surface of a wall is not yet installed or constructed. For example, fixed side wall 20 of housing 12 can be positioned adjacent a stud or beam forming a wall and can be attached thereto by driving a nail through each sleeve 45 of top flange 44A and bottom flange 44B. Thereafter, an exterior panel of a wall, such as drywall, can be positioned over expandable electrical box 10 against front surface 21 of housing 12 and mounting flange 40. The exterior panel of the wall can be provided with a cut-to provide access to interior space 23.

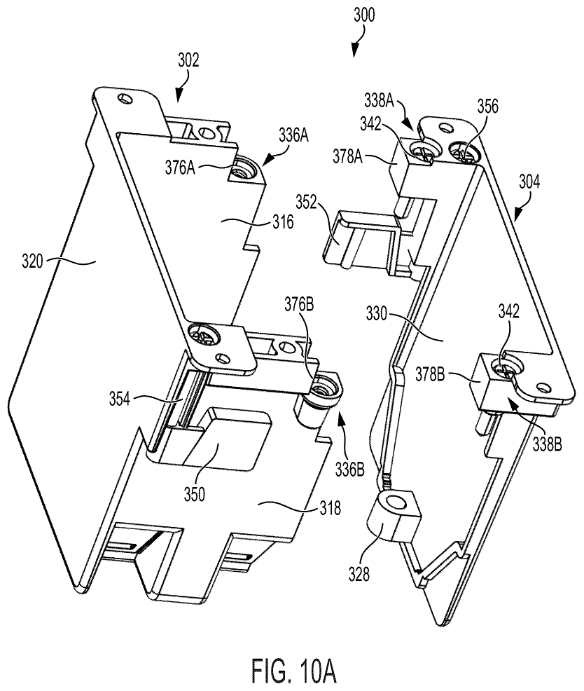

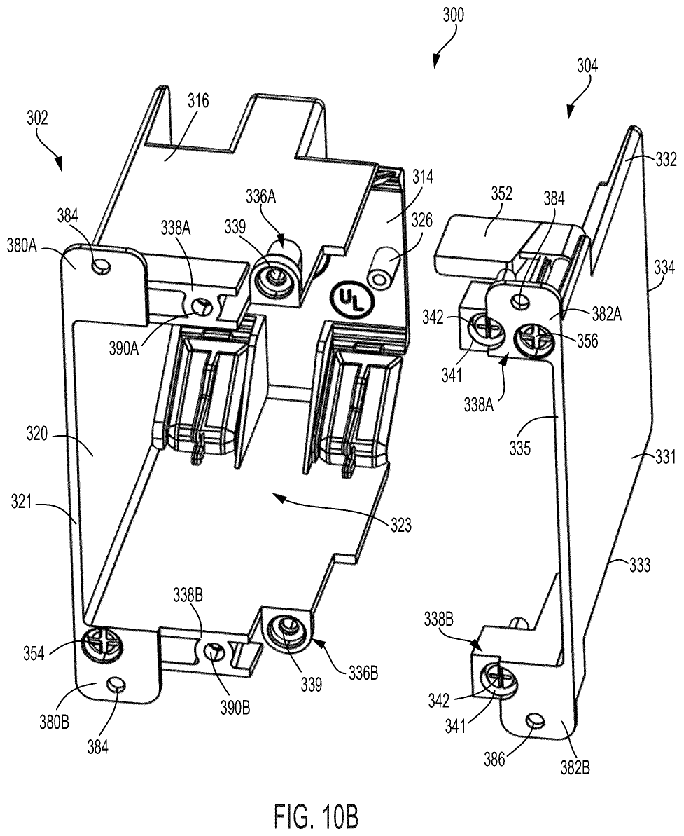

The fixture members or coupling members of the disclosure of the present application, such as fixture member 36A through fixture member 38B, can be assembled together to facilitate easy alignment and secured coupling. Furthermore, fixture member 36A through fixture member 38B can minimize or eliminate occupying of space within interior space 23 and can minimize or eliminate extending beyond front surface 21 of the expandable electrical box. It should be understood that the overall configuration, size, relative dimensions and positioning of fixture member 36A, fixture member 36B, fixture member 38A and fixture member 38B are shown for exemplary purposes only. For example, fixture member 336A, fixture member 336B, fixture member 338A and fixture member 338B of FIG. 10A and FIG. 10B can also be configured according to the disclosure of the present application.

As shown in FIG. 5, expansion member 53 is further provided for expanding the size of expandable electrical box 10. Expansion member 53 can comprise rear expansion wall 52, top expansion wall 54, bottom expansion wall 56, a first open side and a second open side. Top expansion wall 54 can include front face 55 and bottom expansion wall 56 can include front face 57. Expansion receiving member 58, similar to the receiving member 28 of the removable side wall 22, can be mounted on rear expansion wall 52 adjacent to the first open side. Expansion receiving member 58 can be adapted for releasably receiving engaging member 26 of housing 12 to releasably attach expansion member 53 to rear wall 14 of housing 12. Expansion engaging member 60, similar to engaging member 26 of housing 12, can be mounted on rear expansion wall 52 adjacent to the second open side. Expansion engaging member 60 can be adapted for releasable reception by receiving member 28 of removable side wall 22 to releasably attach removable side wall 22 to expansion member 53. Thus, when removable side wall 22 is removed, expansion member 53 can be releasably secured to housing 12 in a similar manner.

Expansion fixture member 62A and expansion fixture member 62B can be respectively mounted on front edges of top expansion wall 54 and bottom expansion wall 56 of expansion member 53, adjacent to the first open side. Expansion fixture member 62A and expansion fixture member 62B are adapted for releasably engaging fixture member 36A and fixture member 36B of housing 12. Similarly, expansion fixture member 64A and expansion fixture member 64B can be respectively mounted on the front edges of top expansion wall 54 and bottom expansion wall 56 of expansion member 53, adjacent to the second open side. Expansion fixture member 64A and expansion fixture member 64B are adapted for releasably engaging with fixture member 38A and fixture member 38B of the removable side wall 22. Expansion fixture member 62A and expansion fixture member 62B each have passage 63 formed therethrough, and expansion fixture member 64A and expansion fixture member 64B each have passage 65 formed therethrough. Passages 63 and passages 65 can be adapted for receiving fasteners 42 or the like to releasably secure expansion member 53 to housing 12 and to removable side wall 22.

Front face 55 can include notch 72A at expansion fixture member 64A and front face 57 can include notch 72B at expansion fixture member 64B to receive fixture member 38A and fixture member 38B, respectively. Expansion fixture member 64A and expansion fixture member 64B can comprise bodies of material projecting outward from top expansion wall 54 and bottom expansion wall 56, respectively. The bodies of material can provide adequate surface area for threads of fasteners 42 to gain purchase with expansion member 53. The bodies of material can project outward from top expansion wall 54 and bottom expansion wall 56 to not interfere with the coupling of top expansion wall 54 and bottom expansion wall 56 with removable side wall 22 so that a contiguous wall structure can be formed and to not occupy space within the interior of expansion member 53 that can be used for storing wiring, etc. Expansion fixture member 62A can comprise extension 74A and body 76A, and expansion fixture member 62B can comprise extension 74B and body 76B. Extension 74A and extension 74B can be configured to mate with notch 48A and notch 48B, respectively. Extension 74A and extension 74B can comprise flanges aligned with front face 55 and front face 57, respectively. Body 76A and body 76B can provide material for the formation of passages 63, respectively. Furthermore, body 76A can comprise a peg (not visible in FIG. 5) and body 76B can comprise a peg (not visible in FIG. 5) that can fit within counterbores in fixture member 36A and fixture member 36B, respectively, surrounding passages 39. Thus, when expansion fixture member 62A and expansion fixture member 62B are engaged with fixture member 36A and fixture member 36B, respectively, front face 55 and front face 57 will be flush with front surface 21, and expansion fixture member 62A and expansion fixture member 62B will be centered and locked with fixture member 36A and fixture member 36B, respectively.

Expansion fixture member 62A, expansion fixture member 62B, expansion fixture member 64A, expansion fixture member 64B, expansion engaging member 60 and expansion receiving member 58 are sized, shaped and configured to match the corresponding parts of housing 12 and removable side wall 22, and therefore any desired number of expansion members 53 can be connected to one another, and/or also connected to housing 12 and removable side wall 22. This allows expandable electrical box 10 to be expanded in size to accommodate any desired number of electrical outlet modules 70, light switch modules 72, etc., as can be seen in FIG. 6. In the non-limiting example of FIG. 6, three expansion members 53 are releasably secured to one another, a rightmost instance of expansion member 53 is releasably secured to housing 12 and a leftmost instance of expansion member 53 is releasably secured to removable side wall 22, thereby resulting in a four-gang box configuration. It should be understood that the electrical outlet modules and light switch module shown in FIG. 6 are shown for exemplary purposes only and other modules (optionally including voids or otherwise empty modules) can similarly be used.

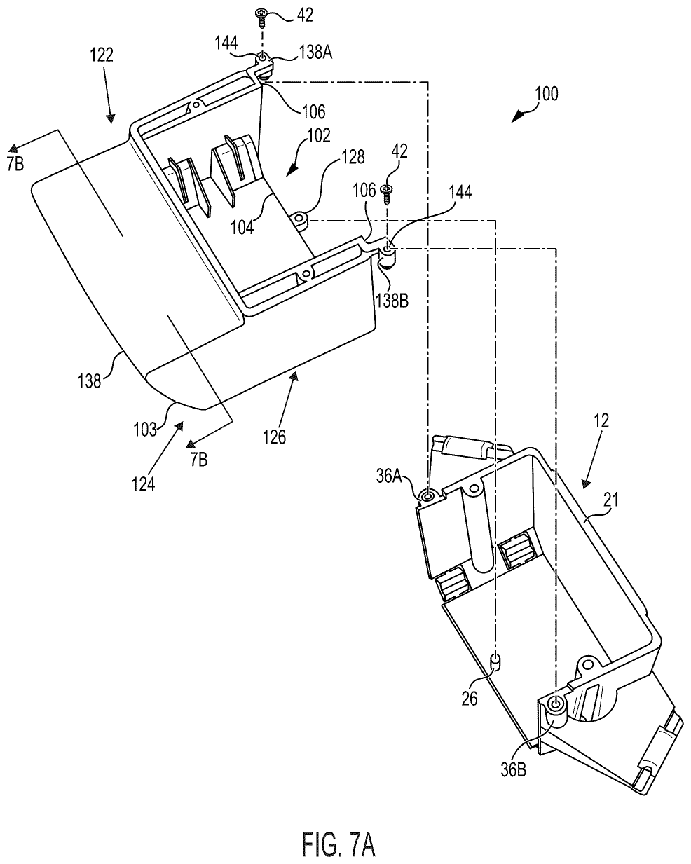

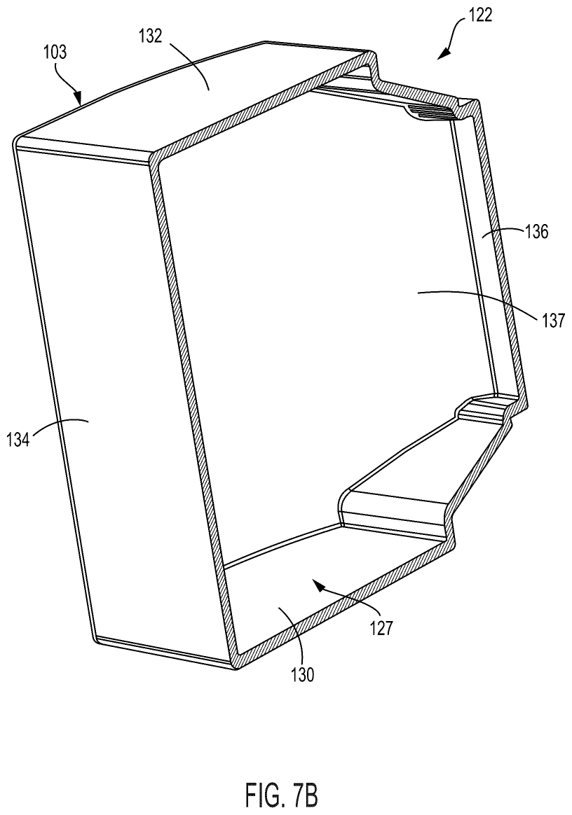

FIG. 7A is a perspective view of expandable electrical box 100 of the present disclosure having auxiliary box 122 exploded from housing 12. Auxiliary box 122 can comprise storage space portion 124 (e.g., a storage compartment) and expansion member portion 126. FIG. 7B is a cross-sectional view through auxiliary box 122 of FIG. 7A showing interior 127 of storage space portion 124. In the example shown in FIG. 7A, auxiliary box 122 can be used in place of, for example, side wall 22. Auxiliary box 122 can provide additional storage space connected to housing 12 to receive electrical components, such as wires.

Auxiliary box 122 of expandable electrical box 100 can comprise open side 102 opposite closed end 103. Closed end 103 can be defined by storage space portion 124. Storage space portion 124 can comprise bottom wall 130, top wall 132, front wall 134, rear wall 136 and side wall 137. Auxiliary box 122 is adapted for releasable attachment to the open side of housing 12 in a similar manner to removable side wall 22. Box receiving member 128 is mounted adjacent to rear edge 140, adjacent to open side 102. Similar to receiving member 28 of removable side wall 22, box receiving member 128 is adapted for releasably receiving engaging member 26 of housing 12 to releasably attach auxiliary box 122 to rear wall 14 of housing 12. Box receiving member 128 can be configured similarly to receiving member 28 of FIG. 3.

Similar to fixture member 38A and fixture member 38B of removable side wall 22, fixture member 138A and fixture member 138B can be respectively mounted on opposed sides of front edges 106 of auxiliary box 122. As such, fixture member 138A can comprise a projection and a body of material similar to extension 49A and body 50A, and fixture member 138B can comprise a projection and a body of material similar to extension 49B and body 50B, as described with reference to FIG. 3. Fixture member 36A and fixture member 36B of housing 12 are adapted for releasably engaging with fixture member 138A and fixture member 138B. Fixture member 138A and fixture member 138B can each have passage 144 formed therethrough for receiving fasteners 42.

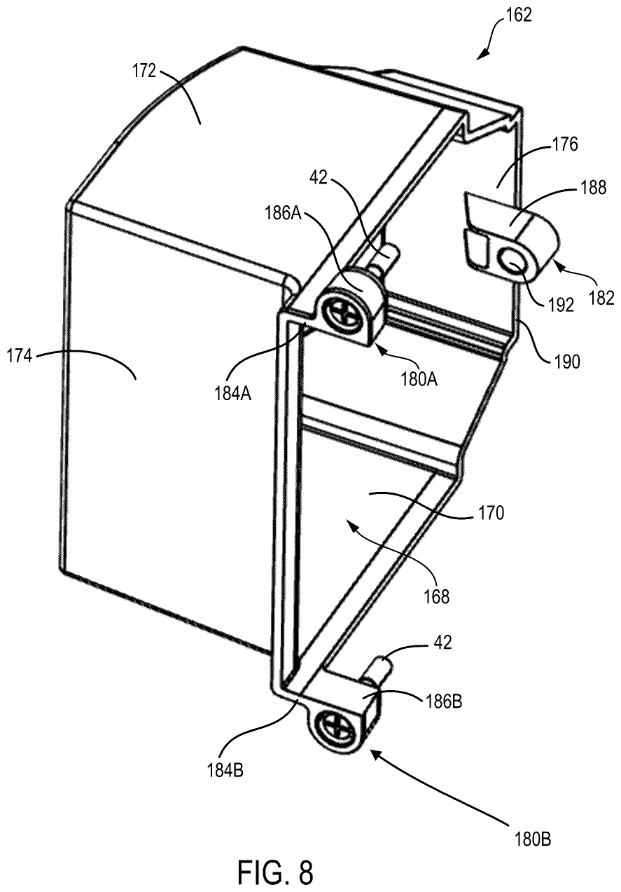

Auxiliary box 122 can be sized to receive a single electrical component, such as one of electrical outlet module 70 and light switch module 72 of FIG. 6. Auxiliary box 122 can include bores 147 to receive fasteners to hold an electrical component in place. Thus, when housing 12 and auxiliary box 122 are assembled, two electrical components can be received and secured. However, in other configurations, as discussed with reference to FIG. 8, an auxiliary box can be configured to not hold an electrical component and only provide additional storage space for wires and the like.

FIG. 8 is a perspective view of auxiliary box 162 having storage space portion 164 (e.g., a storage compartment) configured to be attached directly to another component without an expansion member portion. Storage space portion 164 can comprise interior 168, which can be formed by bottom wall 170, top wall 172, front wall 174, rear wall 176 and side wall 178. Interior 168 of storage space portion 164 includes a compartment that can be used, for example, for storing and securing wires and the like.

Auxiliary box 162 can further comprise fixture member 180A and fixture member 180B and receiving member 182. Fixture member 180A and fixture member 180B can be configured similarly to fixture member 38A and fixture member 38B of FIG. 3. Fixture member 180A can comprise extension 184A and body 186A similar to extension 49A and body 50A, and fixture member 180B can comprise extension 184B and body 186B similar to extension 49B and body 50B, as discussed with reference to FIG. 3.

Receiving member 182 can be configured similarly to receiving member 28 of FIG. 3. Receiving member 182 can comprise flange 188 projecting from rear wall 176 at rear edge 190, wherein flange 188 includes opening 192 to receive engaging member 26 or engaging member 160.

Thus, auxiliary box 162 can be configured similarly to removable side wall 22, wherein interior face 30 and exterior face 31 are expanded or “bumped out” to provide additional storage space. In examples, auxiliary box 122 (FIG. 7A) can comprise an example of a combination of auxiliary box 162 and expansion member 53. In any case, auxiliary box 122 and auxiliary box 162 can be connected directly to housing 12 or to expansion member 53.

It should be understood that expandable electrical box 10 can be provided as part of a kit or system including one or more of housing 12, removable side wall 22 and expansion member 53. One or more of auxiliary box 122 and auxiliary box 162 can also be provided as part of the kit or system.

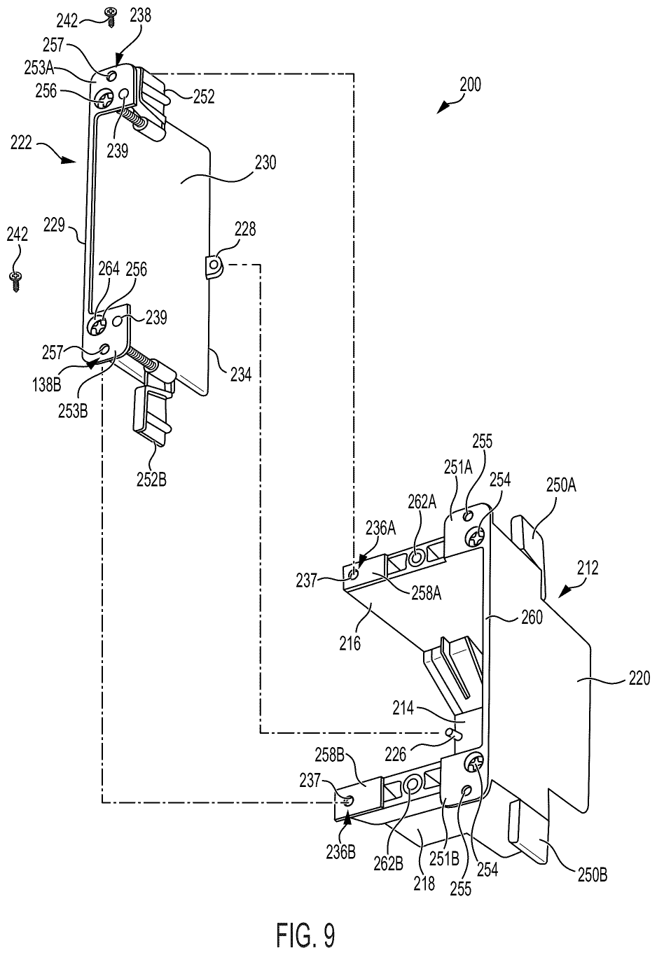

FIG. 9 is an exploded perspective view of expandable electrical box 200 of the present disclosure having pivoting tab 250A and pivoting tab 250B attached to housing 212 and pivoting tab 252A and pivoting tab 252B attached to removable side wall 222. Housing 212 and removable side wall 222 of expandable electrical box 10 are shown for exemplary purposes only and other configurations in accordance with the present disclosure can be used. In the embodiment of FIG. 8, expandable electrical box 200 can be configured as an “old work box” or a “flapper box” that is configured to be fit, e.g., slid, into an opening or cut-out in the exterior of an existing wall, rather than attached to an existing wall structure over which an exterior wall finish is placed. In examples, when expandable electrical box 200 is fully assembled (with or without additional expansion members, as will be discussed below), it can be fit into a cut-out in drywall with pivoting tab 250A, pivoting tab 250B, pivoting tab 252A and pivoting tab 252B rotated to be proximate to or flush with housing 212. Thus, pivoting tab 250A through pivoting tab 252B can be positioned behind the drywall (i.e., within the interior of the wall), with the open face of expandable electrical box 200 facing outwardly. Fixed flange 251A and fixed flange 251B of housing 212 and fixed flange 253A and fixed flange 253B of removable side wall 222 can be pushed against the front of the drywall to prevent expandable electrical box from pass through the opening. Once positioned in place, pivoting tab 250A through pivoting tab 252B can be rotated outwardly into the configuration shown in FIG. 8, thus holding the expandable electrical box 200 within the hole cut in the drywall. Fasteners 254 and fasteners 256, respectively, can then be tightened to tightly and securely press against pivoting tab 250A and pivoting tab 250B and pivoting tab 252A and pivoting tab 252B against the rear surface of the drywall. Pivoting tab 250A through pivoting tab 252B are adjustable, through tightening or loosening of the screws, to releasably clamp the expandable electrical box 200 to the drywall. Additionally, fasteners can be inserted into openings 255 of fixed flange 251A and fixed flange 251B and openings 257 of fixed flange 253A and fixed flange 253B to secure expandable electrical box 200 in place. Accordingly, top flange 44A and bottom flange 44B (FIG. 2) have been omitted in favor of pivoting tab 250A through pivoting tab 252B.

Similar to the previous embodiments, housing 212 can include rear wall 214, top wall 216, bottom wall 218, fixed side wall 220 and an open side opposite of fixed side wall 220. Similar to the previous embodiments, removable side wall 222 can be provided for releasably covering the open side of housing 212. Receiving member 228 is mounted on interior face 230 of removable side wall 222, adjacent to rear edge 234 thereof. Engaging member 226 can be mounted on an interior face of rear wall 214, adjacent to the open side of housing 212. Receiving member 228 can be adapted for releasably receiving engaging member 226 to releasably attach removable side wall 222 to rear wall 214 of housing 212. Although engaging member 226 is shown as having a peg-like shape, and receiving member 228 is shown as being configured to mate with engaging member 226, it should be understood that the size, shape and relative dimensions of engaging member 226 and receiving member 228 are shown for exemplary purposes only, as other shapes and sizes of engaging member 226 and receiving member 228 are also contemplated within the scope of the present subject matter. Receiving member 228 can be configured similarly to receiving member 28 of removable side wall 22 as shown in FIG. 3, and engaging member 226 can be configured similar to engaging member 26 of housing 12 as shown in FIG. 1, thereby allowing a “pull out” configuration.

Fixture member 236A can comprise pad 258A for receiving fixture member 238A such that front face 260 of fixed side wall 220 is flush with front edge 229. Pad 258A can comprise passage 237. A gap can be present between pad 258A and fixed flange 251A so that an electrical component can mount to top wall 216 at opening 262A without extending beyond front face 260.

Fixture member 236B can comprise pad 258B for receiving fixture member 238B such that front face 260 of fixed side wall 220 is flush with front edge 229. Pad 258B can comprise passage 237. A gap can be present between pad 258B and fixed flange 251B so that an electrical component can mount to bottom wall 218 at opening 262B without extending beyond front face 260.

Fixture member 238A can comprise fixed flange 253A, passage 239, opening 257, opening 264, fastener 256 and pivoting tab 252A. Fixture member 238B can comprise fixed flange 253B, passage 239, opening 257, opening 264, fastener 256 and pivoting tab 252B. Fixed flange 253A and fixed flange 253B can extend upward of removable side wall 222 to engage a wall surface. Passages 239 can receive fasteners to attach expandable electrical box 200 to a wall. Openings 257 can be provided to receive a fastener to secure removable side wall 222 to housing 212. Openings 264 can be provided to receive a fastener for joining to passages 237 of housing 212. Fasteners 256 can extend into openings 264 to connect to pivoting tab 252A and pivoting tab 252B. As discussed herein, pivoting tab 252A and pivoting tab 252B can be rotated downward, e.g., horizontally, to allow expandable electrical box 200 to be slid into an opening, and the rotated upward, e.g., vertically, to prevent expandable electrical box 200 from being pulled out of the opening.

Fixture member 236A and fixture member 236B can be respectively mounted on front edges of top wall 216 and bottom wall 218 of housing 212, adjacent to the open side, and fixture member 238A and fixture member 238B can be respectively mounted on opposed sides of front edge 229 of removable side wall 222. Fixture member 236A and fixture member 236B can be adapted for releasably engaging with fixture member 238A and fixture member 238B. Fixture member 236A and fixture member 236B can each have passage 237 formed therethrough and, similarly, fixture member 238A and fixture member 238B can each have passage 239 formed therethrough. Passages 237 and passages 239 can be adapted for receiving fasteners 242 or the like for releasably securing removable side wall 222 to housing 212.

It should be understood that the overall configuration, size, relative dimensions and positioning of fixture member 236A through fixture member 238B are shown for exemplary purposes only.

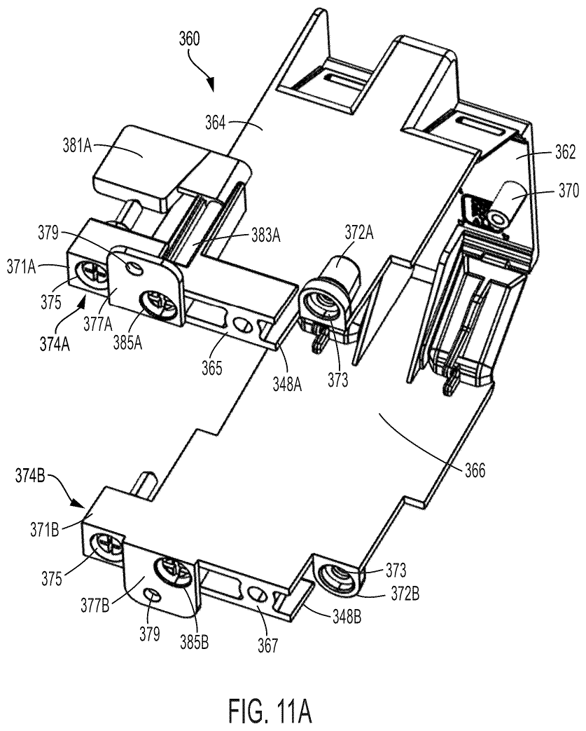

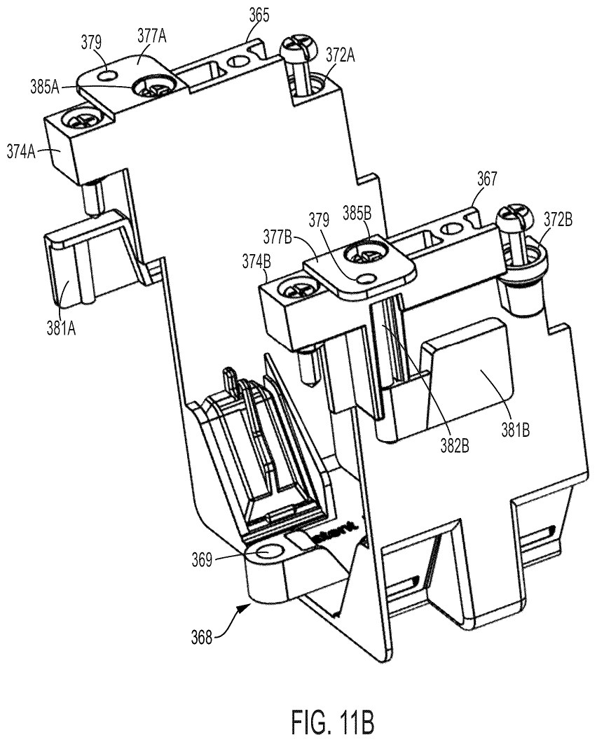

When removable side wall 222 is removed, one or more of expansion members 53, another expansion member or expansion member 360 (FIG. 11A) can be secured to housing 212 in a manner identical or similar to that discussed above with regard to the other embodiments. Similarly, an auxiliary box, such as auxiliary box 122, can also be secured to housing 212 and/or one or more expansion members 53. It should be understood that expandable electrical box 200 can be provided as part of a kit or system including one or more of expansion members 53. One or more of auxiliary box 122 and auxiliary box 162 can also be provided as part of the kit or system. In examples, expansion members 53 can be configured for use with new work boxes and old work boxes. Thus, in examples, fixture member 36A can be substituted for fixture member 236A and fixture member 38A can be substituted for fixture member 238A. However, as discussed with reference to FIG. 10A through FIG. 13, expansion members can be configured specifically for use with old work boxes configured similar to those of FIG. 9.

FIG. 10A and FIG. 10B are exploded perspective views of expandable electrical box 300 of the present disclosure comprising housing 302 and removable side wall 304. Housing 302 can comprise rear wall 314, top wall 316, bottom wall 318, fixed side wall 320 and an open side opposite of fixed side wall 320. Top wall 316, bottom wall 318 and fixed side wall 320 can form front surface 321. Housing 302 can be sized similar to a conventional electrical box for receiving an electrical outlet module, a switch module or the like. The front of housing 302 can be open to, for example, receive an electrical component. For example, the electrical components can comprise one of electrical outlet module 70 and light switch module 72 shown in FIG. 6.

Removable side wall 304 is provided for releasably covering the open side of housing 302. When assembled, rear wall 314, top wall 316, bottom wall 318, fixed side wall 320 and removable side wall 304 form a five-sided receptacle having interior space 323. In examples, rear wall 314, top wall 316, bottom wall 318, fixed side wall 320 and removable side wall 304 can be disposed generally orthogonal to each other such that interior space 323 is generally rectangular shaped, though other configurations can be used.

Removable side wall 304 can be configured to be attached to housing 302 to form interior space 323 to allow the assembly to receive a single electrical component or allow for expansion member 360 (FIG. 11A) to be attached between housing 302 and removable side wall 304 to allow the assembly to receive two electrical components. As discussed herein, removable side wall 304 can be configured to be removed from housing 302 by being translated straight away from rear wall 314 in a direction parallel to fixed side wall 320 in a “pull out” manner.

Removable side wall 304 can comprise top edge 332, bottom edge 333, rear edge 334 and front edge 335. Interior face 330 can be formed between top edge 332, bottom edge 333, rear edge 334 and front edge 335 on an inside surface of removable side wall 304, and exterior face 331 can be formed between top edge 332, bottom edge 333, rear edge 334 and front edge 335 on an exterior surface of removable side wall 304.

Fixture member 336A and fixture member 336B can be respectively mounted on front edges of top wall 316 and bottom wall 318 of the housing 302, adjacent to the open side. Fixture member 338A and fixture member 338B can also be respectively mounted on opposed sides of front edge 335 of the removable side wall 304. Fixture member 336A and fixture member 336B can be adapted for releasably engaging with fixture member 338A and fixture member 338B. Fixture member 336A and fixture member 336B can each have passage 339 formed therethrough and, similarly, fixture member 338A and fixture member 338B can each have passage 341 formed therethrough. Passages 341 can align with passages 339 when removable side wall 304 is engaged with housing 302. Passages 339 and passages 341 can be adapted for receiving fasteners 342 or the like for releasably securing removable side wall 304 to housing 302. It should be understood that the overall configuration, size, relative dimensions and positioning of fixture member 336A and fixture member 336B and fixture member 338A and fixture member 338B are shown for exemplary purposes only.

Expansion receiving member 328, similar to receiving member 28 of removable side wall 22, can be mounted on rear edge 334 adjacent to the first open side of removable side wall 304. Engaging member 326, similar to engaging member 26 of housing 12 of FIG. 1, can be mounted on rear wall 314 proximate the open side. Expansion receiving member 328 can be adapted for releasably receiving engaging member 326 of housing 302 to releasably attach removable side wall 304 to housing 302.

Fixture member 336B can be configured similarly to fixture member 236A of housing 212 of FIG. 9. However, pad 258A can be replaced by notch 376B. Fixture member 336A can be configured similarly to fixture member 236B of housing 212 of FIG. 9. However, pad 258B can be replaced by notch 376A. Fixture member 338A can be configured similarly to fixture member 138B of removable side wall 222 as shown in FIG. 9. However, fixture member 338A can include block 378A. Fixture member 338B can be configured similarly to fixture member 138A of removable side wall 222 as shown in FIG. 9. However, fixture member 338B can include block 378B. Furthermore, fixture member 338B can omit pivoting tab 352.

Fixture member 336A and fixture member 336B can comprise bodies of material projecting outward from top wall 316 and bottom wall 318, respectively. The bodies of material can provide adequate surface area for threads of fasteners 342 to gain purchase with housing 302. The bodies of material can project outward from top wall 316 and bottom wall 318 to not interfere with the coupling of top wall 316 and bottom wall 318 with removable side wall 304 so that a contiguous wall structure can be formed and to not occupy space within the interior of housing 302 that can be used for storing wiring, etc. Fixture member 338A can comprise block 371A, and fixture member 338B can comprise block 371B. Block 371A and block 317B can be configured to mate with notch 376A and notch 376B, respectively. Block 317A and block 371B can comprise flanges aligned with front face 388A and front face 388B, respectively. Block 371A and block 371B can provide material for the formation of passages 375, respectively. Furthermore, block 371A can comprise a peg (not visible in FIG. 10A) and block 371B can comprise a peg (not visible in FIG. 10A) that can fit within counterbores in fixture member 336A and fixture member 336B, respectively, surrounding passages 339. Thus, when fixture member 338A and fixture member 338B are engaged with fixture member 336A and fixture member 336B, respectively, front face 388A and front face 388B will be flush with front edge 335, and fixture member 338A and fixture member 338B will be centered and locked with fixture member 336A and fixture member 336B, respectively.

Expandable electrical box 300 can include fixed flange 380A and fixed flange 380B on housing 302 and fixed flange 382A and fixed flange 382B on removable side wall 304. Fixed flange 380A, fixed flange 380B, fixed flange 382A and fixed flange 382B can be configured similarly as fixed flange 251A, fixed flange 251B, fixed flange 253A and fixed flange 253B of expandable electrical box 200 of FIG. 9. Fixed flange 380A and fixed flange 380B can include passages 384, and fixed flange 382A and fixed flange 382B can include passages 386. Passages 384 and passages 386 can receive fasteners to secure expandable electrical box 300 to an exterior wall surface. A gap can be present between fixed flange 380A and fixed flange 382A so that an electrical component can mount to top wall 316 at opening 390A without extending beyond front face 388A. A gap can be present between fixed flange 380B and fixed flange 382B so that an electrical component can mount to bottom wall 318 at opening 390B without extending beyond front face 388B. The back sides of fixed flange 380A through fixed flange 382B can engage a wall surface to attach expandable electrical box 300 thereto and prevent expandable electrical box from falling or passing into an opening or cut-out in a wall.

Housing 302 can comprise pivoting tab 350. Removable side wall 304 can comprise pivoting tab 352. Pivoting tab 350 can be connected to housing 302 by fastener 354. Pivoting tab 352 can be connected to removable side wall 304 by fastener 356. Pivoting tab 352 can be configured similarly to pivoting tab 250A of housing 212 shown in FIG. 9. Pivoting tab 350 can be configured similar to pivoting tab 252B of removable side wall 222 shown in FIG. 9.

As such, housing 302 and removable side wall 304 can be configured similarly to housing 212 and removable side wall 222 of FIG. 9 with an exception that pivoting tab 252A and pivoting tab 250B can be removed.

FIG. 11A and FIG. 11B are perspective views of expansion member 360 suitable for use with expandable electrical box 300 of FIG. 9. As shown in FIG. 11A and FIG. 11B, expansion member 360 is further provided for expanding the size of expandable electrical box 300. Expansion member 360 can comprise rear expansion wall 362, top expansion wall 364, bottom expansion wall 366, a first open side and a second open side. Top expansion wall 364 can include front face 365 and bottom expansion wall 366 can include front face 367. Expansion receiving member 368, similar to the receiving member 28 of the removable side wall 22, can be mounted on rear expansion wall 362 adjacent to the first open side. Expansion receiving member 368 can be adapted for releasably receiving engaging member 326 of housing 302 at bore 369 to releasably attach expansion member 360 to rear wall 314 of housing 302. Thus, when removable side wall 304 is removed, expansion member 360 can be releasably secured to housing 302 in a similar manner. Expansion engaging member 370, similar to engaging member 26 of housing 12, can be mounted on rear expansion wall 362 adjacent to the second open side. Expansion engaging member 370 can be adapted for releasably reception by expansion receiving member 328 of removable side wall 304 to releasably attach removable side wall 304 to expansion member 360.

Expansion fixture member 372A and expansion fixture member 372B can be respectively mounted on front edges of top expansion wall 364 and bottom expansion wall 366 of expansion member 360, adjacent to the first open side. Front face 365 and front face 367 can include notch 348A at expansion fixture member 372A and notch 348B at expansion fixture member 372B to receive fixture member 338A and fixture member 338B, respectively. Expansion fixture member 372A and expansion fixture member 372B are adapted for releasably engaging fixture member 338A and fixture member 338B of removable side wall 304. Similarly, expansion fixture member 374A and expansion fixture member 374B can be respectively mounted on the front edges of top expansion wall 364 and bottom expansion wall 366 of expansion member 360, adjacent to the second open side. Expansion fixture member 374A and expansion fixture member 374B can comprise block 371A and block 371B, such as extensions or flanges, aligned with front face 365 and front face 367, respectively. Expansion fixture member 374A and expansion fixture member 374B are adapted for releasably engaging with fixture member 336A and fixture member 336B of housing 302. Expansion fixture member 372A and expansion fixture member 372B each have passage 373 formed therethrough, and expansion fixture member 374A and expansion fixture member 374B each have passage 375 formed therethrough. Passages 373 and passages 375 can be adapted for receiving fasteners 342 or the like to releasably secure expansion member 360 to housing 302 and to removable side wall 304. Thus, when expansion fixture member 374A and expansion fixture member 374B are engaged with fixture member 336A and fixture member 336B, respectively, front face 365 and front face 367 will be flush with front face 388A and front face 388B, respectively. Likewise, when expansion fixture member 372A and expansion fixture member 372B are engaged with fixture member 338A and fixture member 338B, respectively, front face 365 and front face 367 will be flush with front face 388A and front face 388B, respectively. Thus, expansion member 360 will be centered and locked with housing 302 and removable side wall 304.

Expansion member 360 can include fixed flange 377A and fixed flange 377B. Fixed flange 377A and fixed flange 377B can be configured similarly as any of the fixed flanges described herein, such as fixed flange 251A, fixed flange 251B, fixed flange 253A and fixed flange 253B of expandable electrical box 200 of FIG. 9. Fixed flange 377A and fixed flange 377B can include passages 379. Passages 379 can receive fasteners to secure expandable electrical box 300 to an exterior wall surface.

Expansion member 360 can comprise pivoting tab 381A and pivoting tab 381B. Pivoting tab 381A can be connected to expansion member 360 by fastener 383A at opening 385A. Pivoting tab 381B can be connected to expansion member 360 by fastener 383B at opening 385B. Pivoting tab 381A and pivoting tab 381B can be configured similarly to any of the other pivoting tabs described herein, such as pivoting tab 250A of housing 212 shown in FIG. 9.

Because expansion fixture member 372A, expansion fixture member 372B, expansion fixture member 374A, expansion fixture member 374B, expansion engaging member 370 and expansion receiving member 368 are sized, shaped and configured to match the corresponding parts of housing 302 and removable side wall 304, any desired number of expansion members 360 can be connected to one another, and also to housing 302 and removable side wall 304. This allows expandable electrical box 300 to be expanded in size to accommodate any desired number of electrical outlet modules 70, light switch modules 72, etc., as can be seen in FIG. 6.

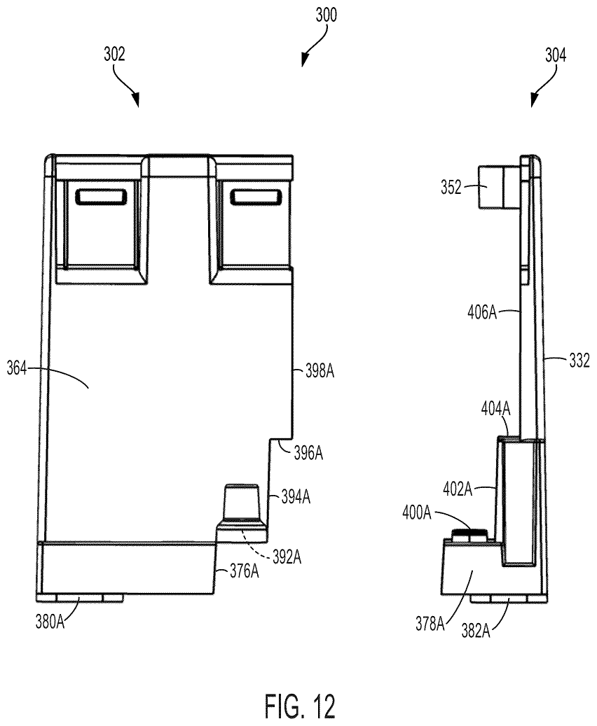

FIG. 12 is a top view of expandable electrical box 300 of FIG. 10A showing interlocking features of housing 302 and removable side wall 304.

The interlocking features of top wall 316 of housing 302 can comprise notch 376A, counterbore 392A, flat face 394A, notch 396A and flat face 398A. Bottom wall 318 of housing 302 can include similar interlocking features. The interlocking features of removable side wall 304 on top edge 332 can comprise block 378A, peg 400A, flat face 402A, notch 404A and flat face 406A. Bottom edge 333 of removable side wall 304 can include similar interlocking features.

When removable side wall 304 is assembled with housing 302, block 378A can fit into notch 376A, peg 400A can seat within counterbore 392A, flat face 402A can engage flush with flat face 394A, notch 404A can seat against notch 396A, and flat face 406A can engage flush with flat face 398A. The interlocking features along bottom wall 318 and bottom edge 333 can similarly engage. As such, relative movement between housing 302 and removable side wall 304 can be inhibited or prevented when assembled and secured together with fasteners 342.

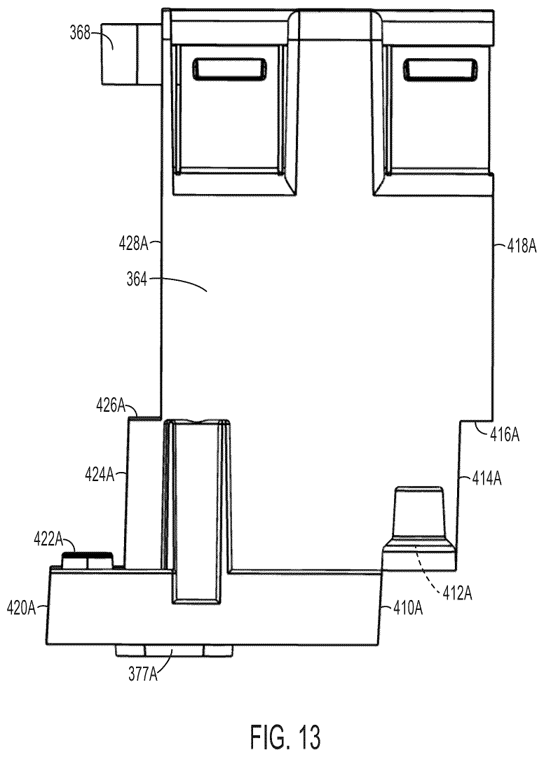

FIG. 13 is a top view of expansion member 360 of FIG. 11A showing interlocking features for engaging with housing 302 and removable side wall 304.

The interlocking features of top expansion wall 364 of expansion member 360 can comprise notch 410A, counterbore 412A, flat face 414A, notch 416A and flat face 418A along a first side. The interlocking features of top expansion wall 364 of expansion member 360 can comprise block 420A, peg 422A, flat face 424A, notch 426A and flat face 428A along a second side. Bottom expansion wall 366 of expansion member 360 can include similar interlocking features.

When expansion member 360 is assembled with housing 302 and removable side wall, block 378A can fit into notch 410A, peg 400A can seat within counterbore 412A, flat face 402A can engage flush with flat face 414A, notch 404A can seat against notch 416A, and flat face 406A can engage flush with flat face 418A, and block 420A can fit into notch 376A, peg 422A can seat within counterbore 392A, flat face 424A can engage flush with flat face 394A, notch 426A can seat against notch 396A, and flat face 428A can engage flush with flat face 398A. The interlocking features along bottom expansion wall 366 engage with housing 302 and removable side wall 304. As such, relative movement between expansion member 360, housing 302 and removable side wall 304 can be inhibited or prevented when assembled and secured together with fasteners 342.

The disclosure of the present application describes an expandable electrical box system with a plurality of components and features, several of which are listed below. However, other components and features contemplated herein can be included though not specifically listed below.
1. Housing: Includes a rear wall, top wall, bottom wall, fixed side wall, and an open side. The front of the housing is open to receive electrical components.
2. Removable side wall: Configured to releasably cover the open side of the housing.
3. Expansion members: Can be added between the housing and removable side wall to increase the size of the electrical box.
4. Auxiliary box: Can be attached in place of the removable side wall to provide additional storage space.
5. Fixture members: The housing and removable side wall, as well as the expansion members and auxiliary boxes, have fixture members that align to receive fasteners, allowing for secure attachment.
6. Interlocking features: Help align and secure the components together.
7. Pivoting tabs: Allow for adjustable clamping to secure the box in place, particularly in an old work context.

The disclosure of the present application provides multiple benefits, several of which are listed below. However, other benefits contemplated herein can be included though not specifically listed below.
1. Modularity: The system allows for easy expansion to accommodate different numbers of electrical components without requiring multiple sizes of electrical boxes.
2. Ease of assembly: The fixture members and interlocking features facilitate easy alignment and secure coupling of components.
3. Versatility: The system can be used for both new construction (“new work”) and existing wall openings (“old work”).
4. Space efficiency: The design minimizes interference with interior space for wiring while providing secure attachment points.
5. Cost-effectiveness: Manufacturers can produce a single expandable system instead of multiple fixed-size boxes, potentially reducing costs.
6. Flexibility: The system can be easily adapted for different configurations and numbers of electrical components.
7. Improved stability: The interlocking features and secure fastening methods provide a rigid and fixed assembly.
8. Additional storage: The auxiliary box option provides extra space for wiring or other components when needed.

Overall, the expandable electrical box systems of the present disclosure offer versatile, user-friendly solutions that address common issues with traditional electrical boxes while providing flexibility for various installation scenarios.

It is to be understood that the expandable electrical boxes of the present disclosure are not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

### EXAMPLES

Example 1 is an expandable electrical box, comprising: a housing comprising: a rear wall, a top wall, a bottom wall and a fixed side wall defining an interior space; an open side opposite the fixed side wall, wherein a front of the housing is open; and a first fixture member connected to the housing; and a removable side wall configured to releasably cover the open side of the housing, the removable side wall comprising: a second fixture member connected to the removable side wall; wherein the first fixture member and the second fixture member are aligned to receive a fastener therethrough.

In Example 2, the subject matter of Example 1 optionally includes wherein: the removable side wall comprises a first flange, wherein the first fixture member is attached to the first flange; and the housing comprises a first notch configured to receive the first flange, wherein the second fixture member extends away from the top wall or the bottom wall of the housing at the first flange.

In Example 3, the subject matter of Example 2 optionally includes wherein: the housing comprises a first front face; the removable side wall comprises a second front face; the first fixture member and the second fixture member are forward-facing to receive the fastener; and the first flange and the first notch are co-planar with the first front face and the second front face.

In Example 4, the subject matter of any one or more of Examples 2-3 optionally include wherein the removable side wall comprises a top surface, a rear surface and a bottom surface, wherein the top surface is configured to align with the top wall, the rear surface is configured to align with the rear wall, and the bottom surface is configured to align with the bottom wall.

In Example 5, the subject matter of Example 4 optionally includes wherein the first flange projects from the removable side wall aligned with the top surface and the first notch extends within the top wall.

In Example 6, the subject matter of Example 5 optionally includes a third fixture member positioned on the bottom wall; and a fourth fixture member positioned on the bottom surface; wherein the third fixture member and the fourth fixture member are aligned to receive a fastener therethrough.

In Example 7, the subject matter of any one or more of Examples 4-6 optionally include a first pivoting tab pivotally secured to the removable side wall at the second fixture member.

In Example 8, the subject matter of Example 7 optionally includes wherein the second fixture member further comprises a first attachment tab comprising a passage for receiving a fastener to secure the expandable electrical box to a wall, wherein the first pivoting tab is rotatable to align with the first attachment tab.

In Example 9, the subject matter of any one or more of Examples 7-8 optionally include a second pivoting tab pivotally secured to the housing.

In Example 10, the subject matter of Example 9 optionally includes wherein the housing comprises a second attachment tab connected to the top wall and including a passage for receiving a fastener to secure the expandable electrical box to a wall, the second attachment tab extending above the top wall to be opposable with the second pivoting tab.

In Example 11, the subject matter of any one or more of Examples 4-10 optionally include a plurality of interlocking features located on the top wall and the bottom wall of the housing; and a plurality of mating interlocking features located on the top surface and the bottom surface of the removable side wall; wherein the plurality of interlocking features and the plurality of mating interlocking features facilitate alignment of the removable side wall and the housing.

In Example 12, the subject matter of Example 11 optionally includes wherein: the set of interlocking features comprise a first plurality of planar surfaces arranged at obliquely to each other; and the set of mating interlocking features comprise a second plurality of planar surfaces arranged to engage fluish with the first plurality of planar surfaces.

In Example 13, the subject matter of any one or more of Examples 2-12 optionally include wherein: the first fixture member comprises a first body comprising a first securing bore positioned outward of the first notch; and the second fixture member comprises a second body comprising a second securing bore positioned outward of the first flange.

In Example 14, the subject matter of any one or more of Examples 1-13 optionally include a receiving member mounted on an interior face of the removable side wall, adjacent a rear edge thereof; and an engaging member mounted on an interior face of the rear wall, adjacent the open side of the housing; wherein the receiving member is adapted for releasably receiving the engaging member to releasably attach the removable side wall to the rear wall of the housing.

In Example 15, the subject matter of any one or more of Examples 1-14 optionally include an expansion member, the expansion member comprising: a rear expansion wall, a top expansion wall, a bottom expansion wall, a first open side and a second open side; a third fixture member configured to engage with the first fixture member of the housing; and a fourth fixture member configured to engage with the second fixture member of the removable side wall.

In Example 16, the subject matter of Example 15 optionally includes an expansion receiving member mounted on the rear expansion wall adjacent the first open side; and an expansion engaging member mounted on the rear expansion wall adjacent the second open side; wherein the expansion receiving member is adapted for releasably receiving an engaging member of the housing and the expansion engaging member is configured to receive a receiving member of the removable side wall to releasably attach the expansion member to the rear wall of the housing.

In Example 17, the subject matter of any one or more of Examples 1-16 optionally include an auxiliary box comprising: a rear auxiliary wall; a top auxiliary wall connected to the rear auxiliary wall; a bottom auxiliary wall connected to the rear auxiliary wall; an open side positioned between the top auxiliary wall and the bottom auxiliary wall; and a closed side connecting the top auxiliary wall and the bottom auxiliary wall, the closed side comprising a storage compartment connectable to the interior space of the housing when the auxiliary box is coupled to the housing; a third fixture member configured to engage with the first fixture member of the housing; and a fourth fixture member configured to engage with the second fixture member of the removable side wall.

Example 18 is a removable wall for an expandable electrical box, the removable wall comprising: a wall panel comprising: a top side; a bottom side; a rear side; a front side; an interior surface bounded by the top side, the bottom side, the rear side and the front side; and an exterior surface bounded by the top side, the bottom side, the rear side and the front side; a first flange extending from interior surface flush the top side and the front side, the first flange comprising a first fastener bore for receiving a first fastener; and a second flange extending from the interior surface flush with the bottom side and the front side, the second flange comprising a second fastener bore for receiving a second fastener.

In Example 19, the subject matter of Example 18 optionally includes a first body connected to the first flange and positioned outward of the top side to define the first fastener bore; and a second body connected to the second flange and positioned outward of the bottom side to define the second fastener bore.

In Example 20, the subject matter of any one or more of Examples 18-19 optionally include a first fixed tab extending outward of the top side proximate the first flange; a first pivoting tab extending from the removable wall opposite the first fixed tab; a second fixed tab extending outward of the bottom side proximate the second flange; and a second pivoting tab extending form the removable wall opposite the second fixed tab.

Example 21 is an expandable electrical box system, comprising: a housing comprising: a rear wall, a top wall, a bottom wall, a fixed side wall and an open side opposite the fixed side wall, wherein a front of the housing is open; and a first fixture member connected to the housing; a removable side wall configured to releasably cover the open side of the housing, the removable side wall comprising: a second fixture member connected to the removable side wall; wherein the first fixture member and the second fixture member are aligned to receive a fastener therethrough; and an expansion member comprising: a rear expansion wall, a top expansion wall, a bottom expansion wall, a first open side and a second open side; a first expansion fixture member mounted on the rear expansion wall adjacent the first open side for engaging the first fixture member of the housing; and a second expansion fixture member mounted on the rear expansion wall adjacent the second open side for engaging the second fixture member of the removable side wall.

In Example 22, the subject matter of Example 21 optionally includes an auxiliary box comprising: a removable expansion wall configured to releasably cover the open side of the housing, the removable expansion wall comprising: a third fixture member connected to the removable expansion wall configured to engage with the first fixture member of the housing; and a storage compartment extending into the removable expansion wall.

### ADDITIONAL EXAMPLES

Example 1 can comprise an expandable electrical box, comprising:

Example 1 is an expandable electrical box, comprising: a housing having a rear wall, a top wall, a bottom wall, a fixed side wall and an open side opposite the fixed side wall, wherein a front of the housing is open; a removable side wall configured to releasably cover the open side of the housing, wherein a receiving member is mounted on an interior face of the removable side wall, adjacent a rear edge thereof; an engaging member mounted on an interior face of the rear wall, adjacent the open side of the housing, wherein the receiving member is adapted for releasably receiving the engaging member to releasably attach the removable side wall to the rear wall of the housing.

In Example 2, the subject matter of Example 1 optionally includes wherein a first pair of fixture members are respectively mounted on front edges of the top wall and the bottom wall of the housing, adjacent the open side.

In Example 3, the subject matter of Example 2 optionally includes wherein a second pair of fixture members are respectively mounted on opposed sides of a front edge of the removable side wall, and wherein the first pair of fixture members is adapted for releasably engaging with the second pair of fixture members.

In Example 4, the subject matter of Example 3 optionally includes wherein the first pair of fixture members each has a passage formed therethrough, and wherein the second pair of fixture members each has a passage formed therethrough, the passages being adapted for receiving screws.

In Example 5, the subject matter of Example 4 optionally includes an expansion member, wherein the expansion member has a rear expansion wall, a top expansion wall, a bottom expansion wall, a first open side and a second open side, wherein an expansion receiving member is mounted on the rear expansion wall adjacent the first open side, and wherein the expansion receiving member is adapted for releasably receiving the engaging member of the housing to releasably attach the expansion member to the rear wall of the housing.

In Example 6, the subject matter of Example 5 optionally includes an expansion engaging member mounted on the rear expansion wall adjacent the second open side, wherein the expansion receiving member is adapted for releasably receiving the engaging member of the removable side wall to releasably attach the removable side wall to the expansion member.

In Example 7, the subject matter of Example 6 optionally includes wherein a first pair of expansion fixture members are respectively mounted on front edges of the top expansion wall and the bottom expansion wall of the expansion member, adjacent the first open side, and wherein the first pair of expansion fixture members is adapted for releasably engaging the first pair of fixture members of the housing.

In Example 8, the subject matter of Example 7 optionally includes wherein a second pair of expansion fixture members are respectively mounted on the front edges of the top expansion wall and the bottom expansion wall of the expansion member, adjacent the second open side, and wherein the second pair of expansion fixture members is adapted for releasably engaging with the second pair of fixture members of the removable side wall.

In Example 9, the subject matter of Example 8 optionally includes wherein the first pair of expansion fixture members each has a passage formed therethrough, and wherein the second pair of expansion fixture members each has a passage formed therethrough, the passages being adapted for receiving screws.

In Example 10, the subject matter of any one or more of Examples 1-9 optionally include an auxiliary box having a wall adapted for releasably covering the open side of the housing, wherein a box receiving member is mounted on an exterior face of the wall of the auxiliary box, adjacent a rear edge thereof, and wherein the box receiving member is adapted for releasably receiving the engaging member of the housing to releasably attach the auxiliary box to the rear wall of the housing.

In Example 11, the subject matter of Example 10 optionally includes wherein a pair of box fixture members are respectively mounted on opposed sides of a front edge of the wall of the auxiliary box, and wherein the first pair of fixture members of the housing is adapted for releasably engaging with the pair of box fixture members.

In Example 12, the subject matter of Example 11 optionally includes wherein the first pair of fixture members each has a passage formed therethrough, and wherein the pair of box fixture members each has a passage formed therethrough, the passages being adapted for receiving screws.

In Example 13, the subject matter of any one or more of Examples 1-12 optionally include at least one first pivoting tab pivotally secured to the housing.

In Example 14, the subject matter of Example 13 optionally includes wherein the at least one first pivoting tab is adjustable for adjustable clamping of the housing.

In Example 15, the subject matter of Example 14 optionally includes at least one second pivoting tab pivotally secured to the removable side wall.

In Example 16, the subject matter of Example 15 optionally includes wherein the at least one second pivoting tab is adjustable for adjustable clamping of the removable side wall.

Example 17 is an expandable electrical box kit, comprising: the expandable electrical box according to Example 1; and at least one expansion member, wherein the at least one expansion member has a rear expansion wall, a top expansion wall, a bottom expansion wall, a first open side and a second open side, wherein an expansion receiving member is mounted on the rear expansion wall adjacent the first open side, and wherein the expansion receiving member is adapted for releasably receiving the engaging member of the housing to releasably attach the expansion member to the rear wall of the housing.

In Example 18, the subject matter of Example 17 optionally includes an auxiliary box having a wall adapted for releasably covering the open side of the housing, wherein a box receiving member is mounted on an exterior face of the wall of the auxiliary box, adjacent a rear edge thereof, and wherein the box receiving member is adapted for releasably receiving the engaging member of the housing to releasably attach the auxiliary box to the rear wall of the housing.

Each of these non-limiting examples can stand on its own, or can be combined in various permutations or combinations with one or more of the other examples.

### VARIOUS NOTES

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An expandable electrical box, comprising:
a housing comprising:
a rear wall, a top wall, a bottom wall and a fixed side wall defining an interior space;
an open side opposite the fixed side wall, wherein a front of the housing is open; and
a first fixture member connected to the housing; and
a removable side wall configured to releasably cover the open side of the housing, the removable side wall comprising:
a second fixture member connected to the removable side wall;
wherein the first fixture member and the second fixture member are aligned to receive a fastener therethrough.

2. The expandable electrical box of claim 1, wherein:
the removable side wall comprises a first flange, wherein the first fixture member is attached to the first flange; and
the housing comprises a first notch configured to receive the first flange, wherein the second fixture member extends away from the top wall or the bottom wall of the housing at the first flange.

3. The expandable electrical box of claim 2, wherein:
the housing comprises a first front face;
the removable side wall comprises a second front face;
the first fixture member and the second fixture member are forward-facing to receive the fastener; and
the first flange and the first notch are co-planar with the first front face and the second front face.

4. The expandable electrical box of claim 2, wherein the removable side wall comprises a top surface, a rear surface and a bottom surface, wherein the top surface is configured to align with the top wall, the rear surface is configured to align with the rear wall, and the bottom surface is configured to align with the bottom wall.

5. The expandable electrical box of claim 4, wherein the first flange projects from the removable side wall aligned with the top surface and the first notch extends within the top wall.

6. The expandable electrical box of claim 5, further comprising:
a third fixture member positioned on the bottom wall; and
a fourth fixture member positioned on the bottom surface;
wherein the third fixture member and the fourth fixture member are aligned to receive a fastener therethrough.

7. The expandable electrical box of claim 4, further comprising a first pivoting tab pivotally secured to the removable side wall at the second fixture member.

8. The expandable electrical box of claim 7, wherein the second fixture member further comprises a first attachment tab comprising a passage for receiving a fastener to secure the expandable electrical box to a wall, wherein the first pivoting tab is rotatable to align with the first attachment tab.

9. The expandable electrical box of claim 7, further comprising a second pivoting tab pivotally secured to the housing.

10. The expandable electrical box of claim 9, wherein the housing comprises a second attachment tab connected to the top wall and including a passage for receiving a fastener to secure the expandable electrical box to a wall, the second attachment tab extending above the top wall to be opposable with the second pivoting tab.

11. The expandable electrical box of claim 4, further comprising:
a plurality of interlocking features located on the top wall and the bottom wall of the housing; and
a plurality of mating interlocking features located on the top surface and the bottom surface of the removable side wall;
wherein the plurality of interlocking features and the plurality of mating interlocking features facilitate alignment of the removable side wall and the housing.

12. The expandable electrical box of claim 11, wherein:
the set of interlocking features comprise a first plurality of planar surfaces arranged at obliquely to each other; and
the set of mating interlocking features comprise a second plurality of planar surfaces arranged to engage fluish with the first plurality of planar surfaces.

13. The expandable electrical box of claim 2, wherein:
the first fixture member comprises a first body comprising a first securing bore positioned outward of the first notch; and
the second fixture member comprises a second body comprising a second securing bore positioned outward of the first flange.

14. The expandable electrical box of claim 1, further comprising:
a receiving member mounted on an interior face of the removable side wall, adjacent a rear edge thereof; and
an engaging member mounted on an interior face of the rear wall, adjacent the open side of the housing;
wherein the receiving member is adapted for releasably receiving the engaging member to releasably attach the removable side wall to the rear wall of the housing.

15. The expandable electrical box of claim 1, further comprising an expansion member, the expansion member comprising:
a rear expansion wall, a top expansion wall, a bottom expansion wall, a first open side and a second open side;
a third fixture member configured to engage with the first fixture member of the housing; and
a fourth fixture member configured to engage with the second fixture member of the removable side wall.

16. The expandable electrical box of claim 15, further comprising:
an expansion receiving member mounted on the rear expansion wall adjacent the first open side; and
an expansion engaging member mounted on the rear expansion wall adjacent the second open side;
wherein the expansion receiving member is adapted for releasably receiving an engaging member of the housing and the expansion engaging member is configured to receive a receiving member of the removable side wall to releasably attach the expansion member to the rear wall of the housing.

17. The expandable electrical box of claim 1, further comprising an auxiliary box comprising:
a rear auxiliary wall;
a top auxiliary wall connected to the rear auxiliary wall;
a bottom auxiliary wall connected to the rear auxiliary wall;
an open side positioned between the top auxiliary wall and the bottom auxiliary wall; and
a closed side connecting the top auxiliary wall and the bottom auxiliary wall, the closed side comprising a storage compartment connectable to the interior space of the housing when the auxiliary box is coupled to the housing;
a third fixture member configured to engage with the first fixture member of the housing; and
a fourth fixture member configured to engage with the second fixture member of the removable side wall.

18. A removable wall for an expandable electrical box, the removable wall comprising:
a wall panel comprising:
a top side;
a bottom side;
a rear side;
a front side;
an interior surface bounded by the top side, the bottom side, the rear side and the front side; and
an exterior surface bounded by the top side, the bottom side, the rear side and the front side;
a first flange extending from interior surface flush the top side and the front side, the first flange comprising a first fastener bore for receiving a first fastener; and
a second flange extending from the interior surface flush with the bottom side and the front side, the second flange comprising a second fastener bore for receiving a second fastener.

19. The removable wall of claim 18, further comprising:
a first body connected to the first flange and positioned outward of the top side to define the first fastener bore; and
a second body connected to the second flange and positioned outward of the bottom side to define the second fastener bore.

20. The removable wall of claim 18, further comprising:
a first fixed tab extending outward of the top side proximate the first flange;
a first pivoting tab extending from the removable wall opposite the first fixed tab;
a second fixed tab extending outward of the bottom side proximate the second flange; and
a second pivoting tab extending form the removable wall opposite the second fixed tab.

21. An expandable electrical box system, comprising:
a housing comprising:
a rear wall, a top wall, a bottom wall, a fixed side wall and an open side opposite the fixed side wall, wherein a front of the housing is open; and
a first fixture member connected to the housing;
a removable side wall configured to releasably cover the open side of the housing, the removable side wall comprising:
a second fixture member connected to the removable side wall;
wherein the first fixture member and the second fixture member are aligned to receive a fastener therethrough; and
an expansion member comprising:
a rear expansion wall, a top expansion wall, a bottom expansion wall, a first open side and a second open side;
a first expansion fixture member mounted on the rear expansion wall adjacent the first open side for engaging the first fixture member of the housing; and
a second expansion fixture member mounted on the rear expansion wall adjacent the second open side for engaging the second fixture member of the removable side wall.

22. The expandable electrical box system of claim 21, further comprising an auxiliary box comprising:
a removable expansion wall configured to releasably cover the open side of the housing, the removable expansion wall comprising:
a third fixture member connected to the removable expansion wall configured to engage with the first fixture member of the housing; and
a storage compartment extending into the removable expansion wall.
